(19) United States
(12) Patent Application Publication
(10) Pub. No.: US 2025/0210970 A1
(43) Pub. Date: Jun. 26, 2025

(54) BATTERY MODULE

(71) Applicant: TOYOTA JIDOSHA KABUSHIKI KAISHA, Toyota-shi (JP)

(72) Inventor: Masayuki SUZUKI, Toyota-shi (JP)

(73) Assignee: TOYOTA JIDOSHA KABUSHIKI KAISHA, Toyota-shi (JP)

(21) Appl. No.: 18/958,049

(22) Filed: Nov. 25, 2024

(30) Foreign Application Priority Data
Dec. 26, 2023 (JP) 2023-219422

(51) Int. Cl. H02H 7/18; H02H 3/06; H02H 3/40

(52) U.S. Cl. CPC H02H 7/18; H02H 3/06; H02H 3/40

(57) ABSTRACT

A battery module is configured to supply electricity to a load connected to an output terminal. The battery module includes: an electricity storage unit; a relay that is provided between the electricity storage unit and the output terminal and configured to perform switching between an electrically conductive state and a cut-off state between the electricity storage unit and the output terminal; and a control unit configured to control a state of the relay. In the battery module, the control unit is configured to control the relay to be in the cut-off state under a condition that an output resistance of the battery module is equal to or more than a first threshold value.

### CROSS-REFERENCE TO RELATED APPLICATION

This application claims priority to Japanese Patent Application No. 2023-219422 filed on Dec. 26, 2023, incorporated herein by reference in its entirety.

### BACKGROUND

### 1. Technical Field

The present disclosure relates to a battery module that supplies electricity to a load connected to an output terminal.

### 2. Description of Related Art

Japanese Unexamined Patent Application Publication No. 2016-048693 (JP 2016-048693 A) discloses a battery module in which a signal cut-off unit is disposed between a voltage sensing terminal, which is electrically coupled to an electrode terminal coupling unit of a battery cell, and a conductive unit coupled to the voltage sensing terminal. In this battery module, safety is improved by interrupting the transmission of detection voltage with use of the signal cut-off unit when a short-circuit of the conductive unit occurs.

### SUMMARY

In the battery module described in JP 2016-048693 A, the battery cell and the conductive unit (in other words, the voltage sensing terminal) are electrically connected to each other. Therefore, even when the transmission of the detection voltage is immediately interrupted when a short-circuit of the conductive unit occurs, the influence of the short-circuit may reach the battery cell.

Thus, in order to further improve the safety of the battery module, it is desired to prevent the influence of the short-circuit between the output terminals from reaching the battery cell even when the output terminals and the like short-circuit.

The present disclosure provides a battery module that is able to reduce influence on a battery cell when a place between output terminals short-circuits.

One aspect of the present disclosure technology is a battery module configured to supply electricity to a load connected to an output terminal. The battery module includes: an electricity storage unit; a relay that is provided between the electricity storage unit and the output terminal and configured to perform switching between an electrically conductive state and a cut-off state between the electricity storage unit and the output terminal; and a control unit configured to control a state of the relay. In the battery module, the control unit is configured to control the relay to be in the cut-off state under a condition that an output resistance of the battery module is equal to or more than a first threshold value.

The battery module may further include a constant current circuit parallelly connected to the relay. The control unit may be configured to regularly perform control of causing a constant current to flow to the output terminal from the electricity storage unit via the constant current circuit and derive the output resistance based on an outflow current of the electricity storage unit and voltage across the output terminal in the control in a period of time in which the relay is in the cut-off state.

The control unit may be configured to control the relay to be in the cut-off state under a condition that the output resistance is less than a second threshold value that is smaller than the first threshold value.

The control unit may be configured to control the relay to be in the conductive state under a condition that the output resistance is equal to or more than the second threshold value and less than the first threshold value.

The control unit may be configured to control the relay to be in the cut-off state under a condition that the control unit senses that the load is removed from the output terminal.

According to the battery module of the present disclosure, under the condition that the output resistance of the battery module is equal to or more than the first threshold value, it is determined that the load is not connected to the output terminal of the battery module, and the relay is controlled to be in the cut-off state and the electricity storage unit and the output terminal are electrically cut apart from each other. By this control, even when the place between the output terminal short-circuits, the influence of the short-circuit on the battery cell can be reduced.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a schematic configuration diagram of a battery module according to one embodiment of the present disclosure;

FIG. 2 is a processing flowchart of connection diagnostic control executed by the battery module; and

FIG. 3 is a diagram describing one example of a result of the connection diagnostic control.

### DETAILED DESCRIPTION OF EMBODIMENTS

A battery module of the present disclosure maintains a battery cell stack (electricity storage unit) and output terminals of the battery module in an electrically cut-off state when a load is not connected to the output terminals when the battery module is individually transported, for example. As a result, even when a situation in which a place between the output terminals short-circuits due to an external factor occurs, the influence thereof on the battery cell stack can be reduced. An embodiment of the present disclosure is described in detail below with reference to the drawings.

### Embodiment

### Configuration

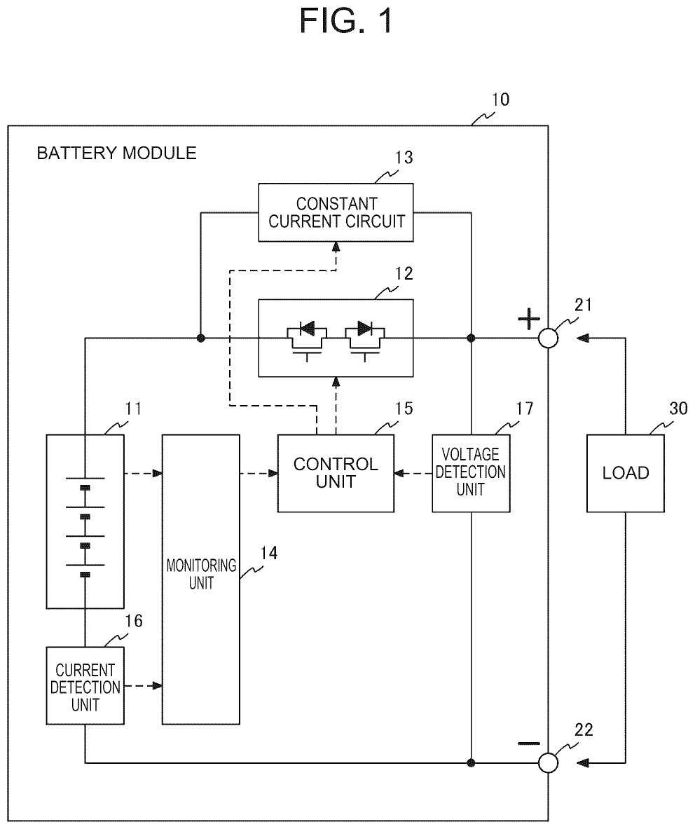

FIG. 1 is a schematic view for describing a configuration of a battery module 10 according to one embodiment of the present disclosure. A battery module 10 exemplified in FIG. 1 is a battery such as a secondary battery that can supply electricity to a load 30. The load 30 is connected to a place between an output terminal 21 on the plus side and an output terminal 22 on the minus side. The battery module 10 is used by being installed in a vehicle, for example.

The battery module 10 includes an electricity storage unit 11, an output relay 12, a constant current circuit 13, a monitoring unit 14, a control unit 15, a current detection unit 16, and a voltage detection unit 17. In FIG. 1, electric power lines through which electricity is exchanged are indicated by solid lines, and signal lines through which detection values, control instructions, and the like flow are indicated by broken lines.

The electricity storage unit 11 is a secondary battery configured to be chargeable and dischargeable such as a lithium ion battery. The electricity storage unit 11 can be a stack configuration in which a plurality of lithium ion battery cells is connected to each other in series. A positive electrode of the electricity storage unit 11 is connected to the output terminal 21 on the plus side via the output relay 12. A negative electrode of the electricity storage unit 11 is connected to the output terminal 22 on the minus side through the current detection unit 16.

The output relay 12 is provided between the electricity storage unit 11 and the output terminal 21 on the plus side and is a configuration for switching an electrical connection state (conductive/cut-off) between the electricity storage unit 11 and the output terminal 21 on the plus side. As the output relay 12, a relay unit in which two field effect transistors (FETs) are connected to each other in series such that rectification directions of body diodes are reversed can be used, for example. The conductive state and the cut-off state of the output relay 12 are controlled by the control unit 15. The output relay 12 may be provided between the electricity storage unit 11 and the output terminal 22 on the minus side.

The constant current circuit 13 is a circuit that can output a current that is a constant value on the basis of an instruction from the control unit 15. The constant current circuit 13 is parallelly connected to the output relay 12, and has a role as a bypass that connects the electricity storage unit 11 and the output terminal 21 on the plus side to each other when connection diagnostic control described below is performed. A well-known circuit can be used as the constant current circuit 13.

The monitoring unit 14 is a configuration for monitoring the state of the electricity storage unit 11 and is a monitoring integrated circuit (IC), for example. The monitoring unit 14 can acquire information on voltage (voltage across each battery cell and the like) from the electricity storage unit 11 and information on a current that flows to the electricity storage unit 11 from the current detection unit 16. The information acquired by the monitoring unit 14 is output to the control unit 15.

The control unit 15 is a configuration for controlling the output relay 12 and the constant current circuit 13 and is a microcomputer, for example. The control unit 15 controls the operation of the output relay 12 and the constant current circuit 13 on the basis of the information relating to the state of the electricity storage unit 11 acquired from the monitoring unit 14 and the voltage between the output terminal 21 on the plus side and the output terminal 22 on the minus side acquired from the voltage detection unit 17.

The current detection unit 16 is a configuration for detecting current (outflow current) flowing from the electricity storage unit 11 and current (inflow current) flowing to the electricity storage unit 11 and is a current sensor, for example.

The voltage detection unit 17 is a configuration for detecting voltage (hereinafter referred to as “voltage between the output terminals”) that appears between the output terminal 21 on the plus side and the output terminal 22 on the minus side and is a voltage sensor, for example.

Some or all of the output relay 12, the constant current circuit 13, the monitoring unit 14, the control unit 15, the current detection unit 16, and the voltage detection unit 17 described above operate by receiving a supply of electricity from the electricity storage unit 11.

### Control

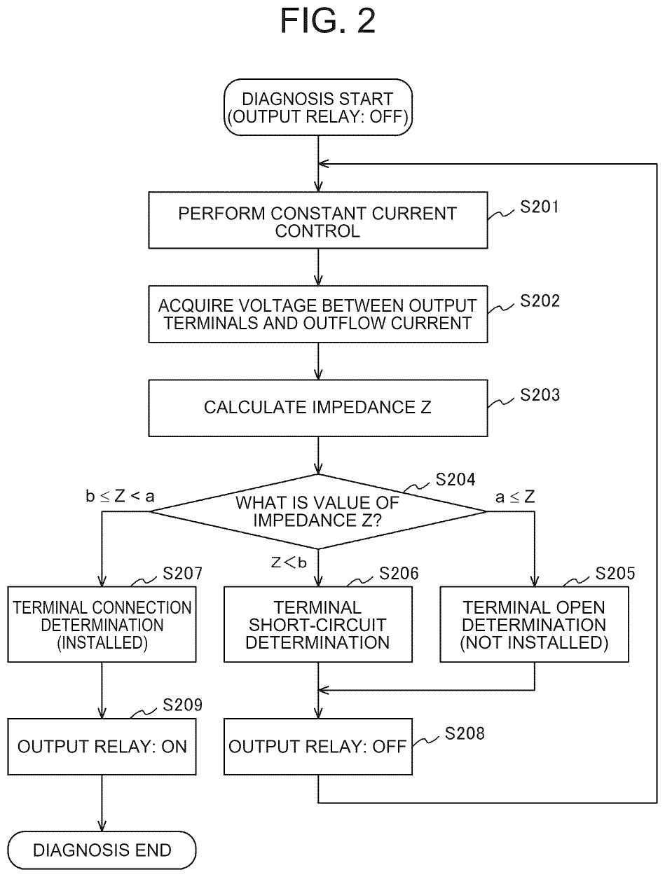

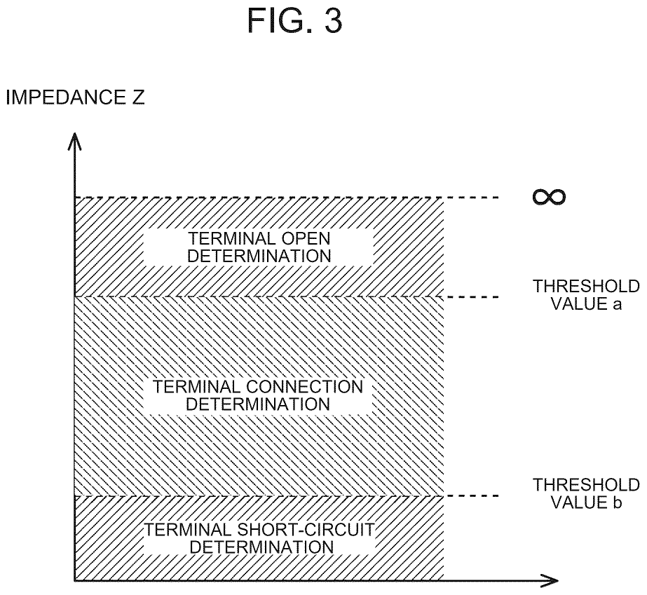

Control performed by the battery module 10 according to the present embodiment is described with further reference to FIG. 2 and FIG. 3. FIG. 2 is a flowchart describing a processing procedure of the connection diagnostic control executed by the control unit 15 of the battery module 10. FIG. 3 is a diagram describing one example of a result of performing the connection diagnostic control in FIG. 2.

The connection diagnostic control shown in FIG. 2 is performed at a predetermined timing in a period of time in which the output relay 12 is in a cut-off state (OFF). In a state in which the load 30 is not connected to a place between the output terminal 25 21 on the plus side and the output terminal 22 on the minus side of the battery module 10, the output relay 12 is controlled to be in a cut-off state (OFF) and the constant current circuit 13 is controlled to be non-operating by the control unit 15. As the state in which the load 30 is not connected to a place between the output terminal 21 on the plus side and the output terminal 22 on the minus side, a scene in which the battery module 10 is individually 30 transported and the like can be exemplified. As the predetermined timing, a timing that arrives at a constant period and the like can be exemplified.

In Step S201, the control unit 15 performs constant current control of operating the constant current circuit 13 and causing a test current to flow from the electricity storage unit 11 toward the output terminal 21 on the plus side for a constant amount of time. The test current is a current that is a constant value. The constant value and the constant amount of time are set to suitable values by taking avoidance of battery drain, output response performance, and the like into consideration on the basis of an electricity storage amount of the electricity storage unit 11, a capacity component connected to an electricity supply destination such as the load 30, and the like. When the constant current control by the constant current circuit 13 is performed by the control unit 15, the processing proceeds to Step S202.

In Step S202, the control unit 15 acquires the voltage between the output terminals of the battery module 10 from the voltage detection unit 17 and acquires the outflow current of the electricity storage unit 11 from the monitoring unit 14. When the voltage between the output terminals and the outflow current is acquired by the control unit 15, the processing proceeds to Step S203.

In Step S203, the control unit 15 derives an impedance Z that is an output resistance of the battery module 10 on the basis of the voltage between the output terminals and the outflow current. The impedance Z can be derived with use of a general law (Ohm's law and the like). The impedance Z may be constantly derived while the constant current control is performed by the constant current circuit 13 or may be derived at a time point at which the constant current control ends after an elapse of a constant amount of time. When the impedance Z is derived by the control unit 15, the processing proceeds to Step S204.

In Step S204, the control unit 15 determines the value of the impedance Z of the battery module 10. This determination is performed by comparison between the impedance Z and a first threshold value a and a second threshold value b. The first threshold value a is set to a great resistance value with which it can be determined that the load 30 is not connected to a place between the output terminal 21 on the plus side and the output terminal 22 on the minus side of the battery module 10. The second threshold value b is set to a value smaller than the first threshold value a and to a small resistance value with which it can be determined that a place between the output terminal 21 on the plus side and the output terminal 22 on the minus side of the battery module 10 is short-circuited. In Step S203, the determination of the value of the impedance Z can be performed as needed when the impedance Z is constantly derived and can be performed at a time point at which the constant current control ends when the impedance Z is derived at a time point at which a constant amount of time has elapsed.

When the control unit 15 determines that the value of the impedance Z is equal to or more than the first threshold value a (Step S204, a≤Z), the processing proceeds to Step S205. When the control unit 15 determines that the value of the impedance Z is less than the second threshold value b (Step S204, Z<b), the processing proceeds to Step S206. Meanwhile, when the control unit 15 determines that the value of the impedance Z is less than the first threshold value a and equal to or more than the second threshold value b (Step S204, b≤Z<a), the processing proceeds to Step S207.

In Step S205, the control unit 15 determines that the battery module 10 is in a “terminal open” state in which the load 30 is not connected to a place between the output terminal 21 on the plus side and the output terminal 22 on the minus side because the impedance Z of the battery module 10 is a high resistance value. In other words, it is determined that the battery module 10 is not installed in a vehicle or the like. When the terminal open determination is performed by the control unit 15, the processing proceeds to Step S208.

In Step S206, the control unit 15 determines that the battery module 10 is in a “terminal short-circuit” state in which a place between the output terminal 21 on the plus side and the output terminal 22 on the minus side is short-circuited because the impedance Z of the battery module 10 is a low resistance value. When the terminal short-circuit determination is performed by the control unit 15, the processing proceeds to Step S208.

In Step S207, the control unit 15 determines that the battery module 10 is in a “terminal connection” state in which the load 30 is connected to a place between the output terminal 21 on the plus side and the output terminal 22 on the minus side because the impedance Z of the battery module 10 is an intermediate resistance value. In other words, the control unit 15 determines that the battery module 10 is installed in a vehicle or the like. When the terminal connection determination is performed by the control unit 15, the processing proceeds to Step S209.

In Step S208, the control unit 15 controls the output relay 12 to be in a cut-off state (OFF). By this control, the electricity storage unit 11 is placed in a state of being electrically cut apart from the output terminal 21 on the plus side. When the output relay 12 is controlled to be in a cut-off state (OFF) by the control unit 15, the processing proceeds to Step S201.

In Step S209, the control unit 15 controls the output relay 12 to be in a conductive state (ON). By this control, the electricity storage unit 11 is electrically connected to the output terminal 21 on the plus side, and the electricity supply from the battery module 10 to the load 30 becomes possible. When the output relay 12 is controlled to be in a conductive state (ON) by the control unit 15, the connection diagnostic control ends.

When the battery module 10 is installed in a vehicle or the like and the connection diagnostic control ends, the connection diagnostic control described above may be restarted when the control unit 15 can sense that the battery module 10 is removed from the vehicle or the like.

FIG. 3 shows an image of the terminal open determination, the terminal short-circuit determination, and the terminal connection determination based on a comparison between the impedance Z of the battery module 10 and the first threshold value a and the second threshold value b.

### Effects

As above, according to the battery module 10 according to one embodiment of the present disclosure, the output relay 12 and the constant current circuit 13 that are parallelly connected to each other are provided between the electricity storage unit 11 and the output terminal 21 on the plus side, and the connection diagnostic control of the output terminals using the test current by the constant current circuit 13 is performed. The control unit 15 causes the output relay 12 to be conducted when it can be determined that the load 30 is connected to a place between the output terminal 21 on the plus side and the output terminal 22 on the minus side of the battery module 10 as a result of the connection diagnostic control. By this control, electricity supply from the battery module 10 to the load 30 becomes possible.

Meanwhile, according to the battery module 10 according to the present embodiment, the control unit 15 cuts off the output relay 12 when it is determined that the load 30 is not connected to a place between the output terminal 21 on the plus side and the output terminal 22 on the minus side of the battery module 10 or it is determined that a place between the output terminal 21 on the plus side and the output terminal 22 on the minus side of the battery module 10 is short-circuited as a result of the connection diagnostic control. By this control, even when the place between the output terminals of the battery module 10 short-circuits, the influence of the short-circuit on the electricity storage unit 11 can be reduced.

The battery module of the present disclosure can be used when the influence of the short-circuit between the output terminals is desired to be prevented from reaching the battery cell, for example.

What is claimed is:

1. A battery module configured to supply electricity to a load connected to an output terminal, the battery module comprising:
an electricity storage unit;
a relay that is provided between the electricity storage unit and the output terminal and configured to perform switching between an electrically conductive state and a cut-off state between the electricity storage unit and the output terminal; and
a control unit configured to control a state of the relay, wherein the control unit is configured to control the relay to be in the cut-off state under a condition that an output resistance of the battery module is equal to or more than a first threshold value.

2. The battery module according to claim 1, further comprising a constant current circuit parallelly connected to the relay, wherein the control unit is configured to regularly perform control of causing a constant current to flow to the output terminal from the electricity storage unit via the constant current circuit and derive the output resistance based on an outflow current of the electricity storage unit and voltage across the output terminal in the control in a period of time in which the relay is in the cut-off state.

3. The battery module according to claim 1, wherein the control unit is configured to control the relay to be in the cut-off state under a condition that the output resistance is less than a second threshold value that is smaller than the first threshold value.

4. The battery module according to claim 3, wherein the control unit is configured to control the relay to be in the conductive state under a condition that the output resistance is equal to or more than the second threshold value and less than the first threshold value.

5. The battery module according to claim 4, wherein the control unit is configured to control the relay to be in the cut-off state under a condition that the control unit senses that the load is removed from the output terminal.
